(19) United States
(12) Patent Application Publication
(10) Pub. No.: US 2025/0390910 A1
(43) Pub. Date: Dec. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Hiromu YAMAWAKI, Tokyo (JP); Toshinori MIYOSHI, Tokyo (JP); Takahiro ISHIKAWA, Tokyo (JP)

(21) Appl. No.: 19/072,405

(22) Filed: Mar. 6, 2025

(30) Foreign Application Priority Data
Jun. 20, 2024 (JP) 2024-099670

(51) Int. Cl. G06Q 30/0251; H04L 51/04; H04L 51/10

(52) U.S. Cl. CPC G06Q 30/0255; H04L 51/04; H04L 51/10

(57) ABSTRACT

An information processing apparatus according to the present application includes a first selection unit, a second selection unit, and an output unit. The first selection unit selects, based on information on a plurality of users participating in a group chat, an advertisement that is to be displayed in a first area of a screen of the group chat. The second selection unit selects, based on a history of conversations held among the users in the group chat, an advertisement that is to be displayed in a second area of the screen of the group chat. The output unit outputs the advertisement selected by the first selection unit and the advertisement selected by the second selection unit.

### CROSS-REFERENCE TO RELATED APPLICATIONS

The present application claims priority to and incorporates by reference the entire contents of Japanese Patent Application No. 2024-099670 filed in Japan on Jun. 20, 2024.

### BACKGROUND OF THE INVENTION

### 1. Field of the Invention

The present invention relates an information processing apparatus, an information processing method, and an information processing program.

### 2. Description of the Related Art

Conventionally, there is a known technology for providing advertisements via a network. For example, Japanese Laid-open Patent Publication No. 2024-027355 proposes a technology for forming a chat group that includes a user and at least one of a staff member in a customer service shop, and a cast who belongs to the customer service shop, and displaying advertisements in a chat room of the chat group.

However, in the conventional technology described above, there is a problem in that advertisements are limited to displaying only the advertisements related to reservations made for the customer service shop in the chat group including the staff or the cast at the customer service shop.

### SUMMARY OF THE INVENTION

An information processing apparatus according to the present application includes a first selection unit, a second selection unit, and an output unit. The first selection unit selects, based on information on a plurality of users participating in a group chat, an advertisement that is to be displayed in a first area of a screen of the group chat. The second selection unit selects, based on a history of conversations held among the users in the group chat, an advertisement that is to be displayed in a second area of the screen of the group chat. The output unit outputs the advertisement selected by the first selection unit and the advertisement selected by the second selection unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating one example of information processing according to an embodiment;

FIG. 2 is a diagram illustrating one example of a configuration of an information processing system according to the embodiment;

FIG. 3 is a diagram illustrating one example of a configuration of an information processing apparatus according to the embodiment;

FIG. 4 is a diagram illustrating one example of a user information table stored in a user information storage unit included in the information processing apparatus according to the embodiment;

FIG. 5 is a diagram illustrating one example of an advertisement information table stored in an advertisement information storage unit included in the information processing apparatus according to the embodiment;

FIG. 6 is a diagram illustrating one example of a chat setting information table stored in chat setting information storage unit included in the information processing apparatus according to the embodiment;

FIG. 7 is a diagram illustrating one example of a conversation history table stored in a conversation history storage unit included in the information processing apparatus according to the embodiment;

FIG. 8 is a diagram illustrating one example of a screen of a group chat that is displayed on a terminal device and that includes a first advertisement and a second advertisement that are output by an output unit included in a processing unit in the information processing apparatus according to the embodiment;

FIG. 9 is a diagram illustrating one example of the first advertisement and the second advertisement that are output by the output unit included in the processing unit in the information processing apparatus according to the embodiment and that are displayed as a carousel display;

FIG. 10 is a diagram illustrating one example of a screen of the first advertisement and the second advertisement that are output by the output unit included in the processing unit in the information processing apparatus according to the embodiment, and the screen of the group chat that includes base information and that is displayed on the terminal device;

FIG. 11 is a flowchart illustrating one example of the information processing performed by the processing unit included in the information processing apparatus according to the embodiment; and

FIG. 12 is a hardware configuration diagram of one example a computer that implements a function of the information processing apparatus according to the embodiment.

### DETAILED DESCRIPTION OF THE PREFERRED EMBODIMENTS

Modes (hereinafter, referred to as an “embodiments”) for carrying out an information processing apparatus, an information processing method, and an information processing program according to the present application will be described in detail below with reference to the accompanying drawings. The information processing apparatus, the information processing method, and the information processing program according to the present application are not limited by the embodiments. Furthermore, each of the embodiments can be appropriately used in combination as long as the content of processes does not conflict with each other. Furthermore, in the embodiments below, the same components are denoted by the same reference numerals and an overlapping description will be omitted.

### 1. One Example of Information Processing

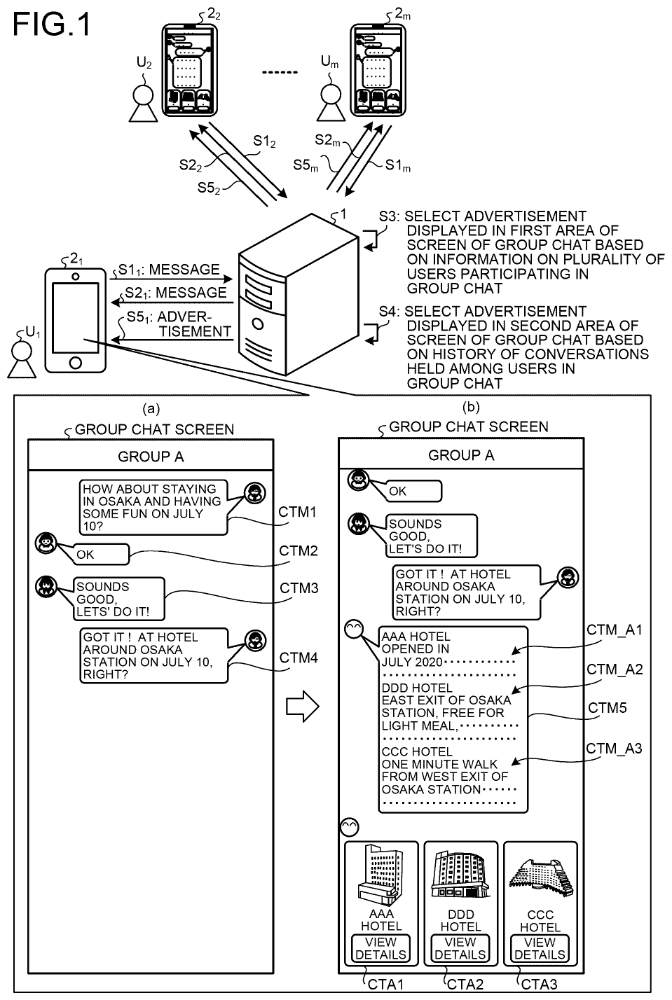

FIG. 1 is a diagram illustrating one example of an information processing according to an embodiment, and, in the present embodiment, an information processing method is performed by the information processing apparatus.

As illustrated in FIG. 1, an information processing apparatus 1 is communicably connected to terminal devices 2₁, 2₂, . . . , and 2ₘ, and sends and receives information to and from the terminal devices 2₁, 2₂, . . . , and 2ₘ. m is an integer equal to or greater than, for example, 3. The information processing apparatus 1 provides an online service including a chat service for sending and receiving messages to and from the terminal devices 2₁, 2₂, . . . , and 2ₘ to users U₁, U₂, . . . , and Uₘ that area used by the terminal devices 2₁, 2₂, . . . , and 2ₘ, respectively.

The terminal device 2₁ is being used by the user U₁, the terminal device 2₂ is being used by the user U₂, and the terminal device 2ₘ is being used by the user Uₘ. The users U₁, U₂, . . . , and Uₘ are participants in the same chat group, and, an application of an instant messenger for conducting a group chat, which is a chat conducted in the chat group, is installed in each of the terminal devices 2₁, 2₂, . . . , and 2ₘ.

The instant messenger is able to send and receive messages in the group chat, is able to send and receive a chat message one to one in the group chat, and is able to send and receive chat messages one to many in the group chat. The messages that are send and received by the instant messenger are, for example, characters, stamps, captured images, or the like.

In a description below, each of the terminal devices 2₁, 2₂, . . . , and 2ₘ may sometimes be referred to as the terminal device 2 in a case where the terminal devices 2₁, 2₂, . . . , and 2ₘ are each referred to without being distinguished from each other, and each of the users U₁, U₂, . . . , and Uₘ may sometimes be referred to as the user U in a case where the users U₁, U₂, . . . , and Uₘ are each referred to without being distinguished from each other. Each of the terminal device 2 is, for example, a smartphone, a tablet personal computer (PC), a notebook personal computer (PC), or the like.

Each of the users U₁, U₂, . . . , and Uₘ operates the respective terminal devices from among the terminal devices 2₁, 2₂, . . . , and 2ₘ, and sends and receives messages to and from in the chat group. Specifically, each of the users U₁, U₂, . . . , and Uₘ operates the respective terminal devices from among the terminal devices 2₁, 2₂, . . . , and 2ₘ, and sends the messages exchanged in the group chat to the information processing apparatus 1 via a network (not illustrated) (Steps S1₁, S1₂, . . . , and S1ₘ).

The information processing apparatus 1 receives a message of a group chat sent from each of the terminal devices 2₁, 2₂, . . . , and 2ₘ, and sends, via the network (not illustrated), the received message of the group chat to the terminal devices 2 used by the respective users U other than the user U how has sent the message (Steps S2₁, S2₂, . . . , and S2ₘ). Each of the terminal devices 2₁, 2₂, . . . , and 2ₘ receives the chat message that is the message exchanged in the group chat and that has been sent from the information processing apparatus 1, and then displays the received chat message.

In the example indicated by (a) illustrated in FIG. 1, chat messages CTM1 and CTM4 sent by the user U₁, a chat message CTM2 sent by the user U₂, and a chat message CTM3 sent by the user Uₘ are displayed on the terminal device 2₁. Furthermore, the name of the chat group is a group A.

Then, the information processing apparatus 1 selects an advertisement to be displayed on a first area on a group chat screen that is a screen of the group chat, on the basis of the information on the plurality of users U₁, U₂, . . . , and Uₘ participated in the group chat indicated by the group A (Step S3).

At the process at Step S3, the information processing apparatus 1 selects a first advertisement that is an advertisement to be displayed on the first area, on the basis of the information on the plurality of users U₁, U₂, . . . , and Uₘ participating in the group chat indicated by the group A and on the basis of the content of the chat message posted by one of the users from among the plurality of users U₁, U₂, . . . , and Uₘ.

The information on each of the plurality of users U₁, U₂, . . . , and Uₘ is, for example, attribute information or a behavior history indicating an attribute of each of the plurality of users U₁, U₂, . . . , and Uₘ. The attribute of the user U is, for example, a demographic attribute, a psychographic attribute, or the like. The demographic attribute is an attribute in terms of a demographic characteristic of the user U. The psychographic attribute is an attribute indicating, for example, interests and concerns of the user U, a sense of values of the user U, a life style of the user U, a personality of the user U, or the like. The behavior history is, for example, a behavior history of each of the users U exhibited online, but may also include a behavior history of each of the users U exhibited offline.

At the process at Step S3, the information processing apparatus 1 estimates a persona exhibited by the group A that is the group of the plurality of users U₁, U₂, . . . , and Uₘ, on the basis of the attribute information on the plurality of users U₁, U₂, . . . , and Uₘ.

For example, the information processing apparatus 1 determines, on the basis of the attribute information on the plurality of users U₁, U₂, . . . , and Uₘ, a common characteristic exhibited by the plurality of users U₁, U₂, . . . , and Uₘ as the persona exhibited by the group. The common characteristic exhibited by the plurality of users U₁, U₂, . . . , and Uₘ is, for example, an attribute, interests and concerns, a behavior pattern, or the like that is common to the plurality of users U₁, U₂, . . . , and Uₘ, but the common characteristic is not limited to this example.

The common attribute is, for example, an age group, gender, a family, an occupation, or the like, but is not limited to this example. The common interests and concerns are, for example, a love of cars, a love of shopping, a love of travelling, and the like, but are not limited to these examples. The common behavior pattern is, for example, traveling once a month, eating out three or more times a weekday evening, go shopping every weekend, or the like, but is not limited to this example.

In the example indicated by (a) illustrated in FIG. 1, the information processing apparatus 1 selects the first advertisement on the basis of the latest chat message CTM4 from among the chat messages CTM1, CTM2, CTM3, and CTM4 sent by the user U₁, U₂, Uₘ, respectively, and on the basis of the persona exhibited by the group A. The latest chat message CTM4 is information on the character string indicating that “Got it ˜! At a hotel around Osaka station on July 10, right?”.

The information processing apparatus 1 uses a natural language processing technique, a regular expression, or the like, and extracts the words of “July 10”, “around Osaka station”, and “hotel” as the information on the specific date, the specific area, and the location type, respectively, from, for example, the chat message CTM4. Furthermore, the information processing apparatus 1 is also able to extract the information on the specific date, the specific area, and the location type from, for example, the chat message CTM4 by using generative Artificial Intelligence (AI), such as a large language model (LLM).

The information processing apparatus 1 acquires, from an internal database or an external database, a hotel list that is a list of hotels that are located in a specific area and that are available on a specific date from the information on the specific date, the specific area, the location type, and the like. Furthermore, the information processing apparatus 1 acquires, from the internal database or the external database, the attribute information (for example, a site location, a price range, a facility, a service, a room type, a review rating, etc.) on each of the hotels included in the hotel list.

The information processing apparatus 1 selects the first advertisement on the basis of the attribute information on each of the hotels included in the hotel list and on the basis of the persona exhibited by the group A. For example, the information processing apparatus 1 causes a first learning model to output a score of each of the advertisements by using the first learning model that outputs a score indicating the probability that the advertisement will be selected by using the information that includes both of the attribute information on each of the hotels included in the hotel list and the persona exhibited by the group A as input information.

The information processing apparatus 1 selects, on the basis of the score of each of the advertisements output from the first learning model, the predetermined number of N1 advertisements defined in descending order of scores as the first advertisement. The first learning model is a model of, for example, a logistic regression model, a neural network, or the like, but is not limited to this example.

Moreover, in the example described above, the information processing apparatus 1 narrows down the location indicated by the location type by using the chat message CTM4, but the information processing apparatus 1 is also able to narrow down the location indicated by the location type by using the chat message CTM1, or the like. Furthermore, the information processing apparatus 1 is also able to select the first advertisement on the basis of the persona exhibited by the group without using the chat message CTM4.

Furthermore, the information processing apparatus 1 selects, on the basis of the history of the conversations held among the users U₁, U₂, . . . , and Uₘ in the group chat, the second advertisement that is the advertisement to be displayed in a second area on the group chat screen that is the screen of the group chat (Step S4). The second area is an area that is different from the first area described above.

The information processing apparatus 1 is able to select the second advertisement displayed on the second area, on the basis of the content of the chat message that has been posted by, for example, one of the users U from among the plurality of users U₁, U₂, . . . , and Uₘ and on the basis of the history of the conversations held among the users U in the chat room of the group chat before the chat message is posted.

The chat message that has been posted one of the users U among the plurality of users U₁, U₂, . . . , and Uₘ is the latest chat message that has been posted in the chat room of the group chat, but the chat message is not limited to this example.

The information processing apparatus 1 is able to cause the generative AI to generate advertisement condition information that indicates a second advertisement condition that is a condition for the advertisement to be displayed in the second area by inputting the information including the history of the conversations held among the users U₁, U₂, . . . , and Uₘ to the generative AI as input information.

The second advertisement condition is a condition that is used at the time of a selection of the second advertisement to be provided to the group. For example, the second advertisement condition includes a condition for defining a category targeted for an advertisement (for example, a category of a service targeted for an advertisement or a category of a product targeted for an advertisement), a target group (age, gender, an occupation, interests and concerns, etc.), a category of a format of an advertisement (for example, a moving image advertisement, a banner advertisement, a native advertisement, etc.), or the like.

The category of the service is, for example, an accommodation service provided by a hotel, a food and beverage service provided by an eating house, a catering service provided by an eating house, or the like, but the category of the service is not limited to this example. In a case where the category targeted for the advertisement is a hotel, the second advertisement condition is able to include a condition for the date of use, an area, the number of persons staying, or the like. Furthermore, in a case where the category targeted for the advertisement is an eating house, the second advertisement condition is able to include a condition of date and time of use, a genre of an eating house, an area, the number of persons dining, or the like.

The generative AI is, for example, text generative AI. The text generative AI is a large language model that has been trained, for example, to estimate and output a subsequent token from an input token string, and is, for example, a transformer based model, a recurrent neural network (RNN) based model, or the like.

The transformer based model is, for example, a generative pre-trained transformer (GPT), or the like, but is not limited to this example. The RNN based model is, for example, a receptance weighted key value (RWKV), or the like, but is not limited to this example.

Moreover, the generative AI may also be a language model that has been dedicatedly trained (for example, fine-tuning) to generate reply information. The generative AI is arranged in an external information processing apparatus, and the information processing apparatus 1 uses the generative AI via an application programming interface (API), but the generative AI may be arranged in the information processing apparatus 1.

The information processing apparatus 1 causes the generative AI to generate the advertisement condition information indicating the second advertisement condition that is the condition for the advertisement to be displayed in the second area by inputting information including, for example, both of the history of the conversations held among the users U₁, U₂, . . . , and Uₘ and instruction information that is information on the character string indicating that “Please specify a condition for the advertisement to be suggested to the user group having a given conversation.” to the generative AI as input information.

Moreover, information indicating an exemplification in which a history example of conversations is associated with a condition example of an advertisement to be suggested may be included in the instruction information, and, as a result of this, it is possible to cause the generative AI to generate the advertisement condition information with high accuracy. Furthermore, the generative AI may also be the generative AI that has been trained by fine-tuning, or the like by using data set of the history of the conversations held by the plurality of users U and the advertisement condition information, or the like, and, in this case, the instruction information does not need to be included in the input information that is input to the generative AI.

Furthermore, the information processing apparatus 1 is also able to cause the generative AI to generate the advertisement condition information by inputting the information including both of the information (for example, the attribute information or a behavior history) on the plurality of users U and the history of the conversations held among the users U to the generative AI as input information. For example, the information processing apparatus 1 causes the generative AI to generate the advertisement condition information by inputting the information including both of the information on the plurality of users U, the history of the conversations held among the users U, and the instruction information to the generative AI as input information.

In this case, the instruction information is, for example, the information on the character string indicating that “Please specify a condition for the advertisement to be suggested to the group of the plurality of users each having the given attribute and each having the given conversation.”, but the instruction information is not limited to this example. In this case, also, the information indicating an exemplification in which a combination example of the information on the plurality of users U and the history of the conversations is associated with a condition example of an advertisement to be suggested, or the like may be included in the instruction information.

Furthermore, the information processing apparatus 1 is able to cause the generative AI to generate the advertisement condition information by inputting the information including the information on the plurality of users U, the content of the chat message posted by one of the users U from among the plurality of users U₁, U₂, . . . , and Uₘ, and the history of the conversations held among the users U in the chat room of the group chat before the chat message is posted to the generative AI as input information.

For example, the information processing apparatus 1 causes the generative AI to generate the advertisement condition information by inputting the information including the information on the plurality of users U, the content of the chat message posted by user U, the history of the conversations of the group chat held among the users U in the chat room before the chat message is posted, and the instruction information to the generative AI as input information.

In this case, the instruction information is, for example, the information on the character string indicating that “Please specify a condition for the advertisement to be suggested to the group of the plurality of users each having the given attribute and each are having the given conversations. For the condition for the advertisement to be suggested, please place the most importance on the latest message.”, but the instruction information is not limited to this example.

In this case, also, the information indicating an exemplification in which a combination example of the information on the plurality of users U, the history of conversations, and the latest message is associated with the condition example of an advertisement to be suggested may be included in the instruction information. The message is the latest chat message from among the plurality of chat messages that are included in the input information.

The information processing apparatus 1 selects the second advertisement to be displayed in the second area on the basis of the advertisement condition information generated in the manner described above. For example, in a case where the information (for example, the information on the accommodation date and time, the accommodation area, etc.) related to the accommodation service is included in the advertisement condition information that has been generated in the manner described above, the information processing apparatus 1 acquires, from the internal database or the external database, the hotel list that is the list of the hotels that are located in the accommodation area and that are available on the accommodation date and time from the information related to the accommodation service. Furthermore, the information processing apparatus 1 acquires, from the internal database or the external database, the attribute information (for example, a site location, a price range, a facility, a service, a room type, a review rating, etc.) on each of the hotels included in the hotel list.

The information processing apparatus 1 selects the first advertisement on the basis of the attribute information on each of the hotels included in the hotel list and the persona exhibited by the group A. For example, the information processing apparatus 1 causes the second learning model to output a score of each of the advertisements by using the second learning model that outputs a score indicating the probability that the advertisement will be selected by using the information that includes both of the attribute information on each of the hotels included in the hotel list and the information (a target group, information on a category of a format of an advertisement, etc.) included in the advertisement condition information that has been generated as described above as input information.

The information processing apparatus 1 selects, on the basis of the score of each of the advertisements output from the second learning model, the predetermined number of N2 advertisements defined in descending order of scores as the second advertisement. The second learning model is a model of, for example, a logistic regression model, a neural network, or the like, but is not limited to this example.

Furthermore, the information processing apparatus 1 inputs the information including information that instructs to generate a base of the second advertisement condition indicated by the advertisement condition information to the generative AI as input information, and causes the generative AI to generate the base information that is the information indicating the base of the second advertisement condition indicated by the advertisement condition information and that is displayed on the screen of the group chat.

The information processing apparatus 1 is able to cause the generative AI to generate the base information that is the information indicating the base of the second advertisement condition indicated by the advertisement condition information by further including the information on, for example, the character string indicating that “Furthermore, please output a sentence indicating the base for specifying the condition for the advertisement” in the instruction information. The information processing apparatus 1 is able to enhance the accuracy of the condition of the second advertisement specified by the generative AI by causing the generative AI to output the base information.

The base information is information on, for example, the information on the character string indicating that “Because we are looking for a hotel around Osaka station”, the information on the character string indicating that “Because we are so excited about our trip to Okinawa”, or the like, but the base information is not limited to this example.

Subsequently, the information processing apparatus 1 outputs both of the first advertisement that has been selected at Step S3 and the second advertisement that has been selected at Step S4 to the terminal devices 2₁, 2₂, . . . , and 2ₘ (Steps S5₁, 5₂, . . . , and 5ₘ). As a result of this, in each of the terminal devices 2₁, 2₂, . . . , and 2ₘ, both of the first advertisement selected at Step S3 and the second advertisement selected at Step S4 are displayed on the chat room of the group A.

In the example indicated by (b) illustrated in FIG. 1, the advertisement CTA1, the advertisement CTA2, the advertisement CTM_A1, and the advertisement CTM_A2 are the first advertisements, and the advertisement CTA3 and the advertisement CTM_A3 are the second advertisement. The advertisement CTA1 and the advertisement CTM_A1 are advertisements of an AAA hotel, the advertisement CTA2 and the advertisement CTM_A2 are advertisements of a DDD hotel, and the advertisement CTA3 and the advertisement CTM_A3 are advertisements of a CCC hotel.

The area in which the advertisement CTA1, the advertisement CTA2, the advertisement CTM_A1, and the advertisement CTM_A2 are displayed is the first area, and the area in which the advertisement CTA3 and the advertisement CTM_A3 are displayed is the second area, but the area is not limited to this example.

The advertisement CTM_A1, the advertisement CTM_A2, and the advertisement CTM_A3 are text advertisements that are the advertisements in a message format, and are displayed in the same display mode as the display mode of the chat messages that are exchanged in the group chat and that are displayed on the screen. Each of the advertisement CTA1, the advertisement CTA2, and the advertisement CTA3 is a banner advertisement in which an image, a text, and a link are included, and is an advertisement displayed as a carousel display, so that these advertisements are sometimes called card advertisements.

Furthermore, in the example indicated by (b) illustrated in FIG. 1, in an area that is outside of the display area of the terminal device 2, an advertisement CTA4 (not illustrated) or the like is also included in the second advertisement that is selected by the information processing apparatus 1 and that is provided to the terminal device 2.

Both of the first area and the second area are arrayed in a direction (in a horizontal direction in (b) illustrated in FIG. 1) perpendicular to an array direction (in a vertical direction in (b) illustrated in FIG. 1) of the chat messages that are exchanged in the group chat and that are displayed on the screen. Then, in the area including both of the first area and the second area, the advertisements CTA1 and CTA2 that are the first advertisement and advertisements CTA3 and CTA4 that are the second advertisement are displayed as a carousel display.

The carousel display is performed in accordance with a specific operation (for example, a flick operation or a scroll operation) performed on the terminal device 2 by the user U, but may also be automatically performed. The carousel display of each of the advertisements CTA1 and CTA2 that are the first advertisement and advertisements CTA3 and CTA4 that are the second advertisement is performed as a result of a movement of the first area and the second area in the array direction.

Furthermore, the information processing apparatus 1 is also able to output the base information generated at Steps S5₁, S5₂, . . . , and S5ₘ to the terminal devices 2₁, 2₂, . . . , and 2ₘ. The information processing apparatus 1 outputs the base information to the terminal devices 2₁, 2₂, . . . , and 2ₘ, for example, after the second advertisement has been output to the terminal devices 2₁, 2₂, . . . , and 2ₘ or before the second advertisement is displayed on the terminal devices 2₁, 2₂, . . . , and 2ₘ.

As a result of this, in each of the terminal devices 2₁, 2₂, . . . , and 2ₘ, after the second advertisement has been displayed or before the second advertisement is displayed on the chat room of the chat group, the base information is displayed on the chat room of the chat group. Accordingly, the users U₁, U₂, . . . , and Uₘ are able to easily figure out the reason that the second advertisement has been displayed, and the information processing apparatus 1 is able to enhance an advertising effect of the advertisements.

In this way, the information processing apparatus 1 selects, on the basis of the information on the plurality of users U participating in the group chat, the advertisement to be displayed in the first area of the screen of the group chat as the first advertisement, and selects, on the basis of the history of conversations held among the users U of the group chat, the advertisement to be displayed in the second area of the screen of the group chat as the second advertisement. As a result of this, the information processing apparatus 1 is able to improve selectivity of the advertisements displayed in the chat room of the group chat.

In the following, a configuration of an information processing system that includes the information processing apparatus 1 and the terminal devices 2₁ to 2ₘ that perform the processes described above, and the like will be described in detail.

### 2. Configuration of Information Processing System

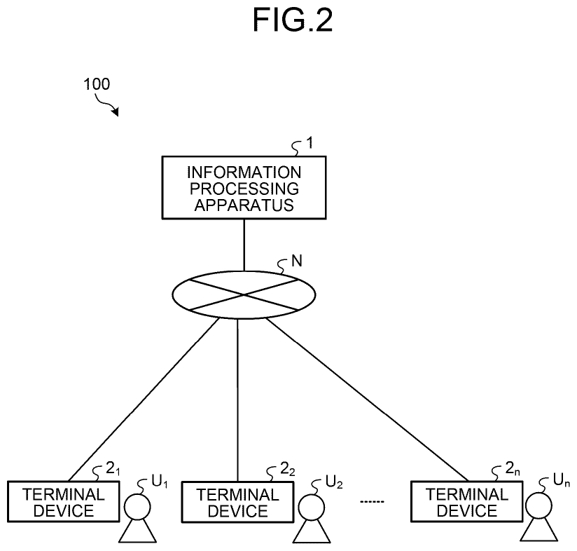

FIG. 2 is a diagram illustrating one example of a configuration of the information processing system according to the embodiment. As illustrated in FIG. 2, an information processing system 100 according to the embodiment includes the information processing apparatus 1, and the plurality of terminal devices 2₁, 2₂, . . . , and 2ₙ. n is an integer equal to or greater than, for example, m described above.

The plurality of terminal devices 2₁, 2₂, . . . , 2ₙ are used by different users U₁, U₂, . . . , Uₙ, respectively. Each of the terminal devices 2₁, 2₂, . . . , and 2ₙ is, for example, a notebook personal computer (PC), a desktop personal computer (PC), a smartphone, a tablet personal computer (PC), or a wearable device. The wearable device is, for example, smart glasses or a smart watch, or the like, but is not limited to this example.

The information processing apparatus 1 and the terminal devices 2₁, 2₂, . . . , and 2ₙ are communicably connected to each other via a network N in a wired or wireless manner. Moreover, in the information processing system 100 illustrated in FIG. 2, two or more of the information processing apparatuses 1 may be included.

The network N includes, for example, a wide area network (WAN), such as the Internet, and mobile telecommunications networks, such as long-term evolution (LTE), 4th generation (4G), and 5th generation (5th generation mobile communication system: 5G).

The terminal devices 2 are connected to the network N via near field wireless communication, such as a mobile communication network, Bluetooth (registered trademark) or a wireless local area network (LAN), and are capable of communicating with the information processing apparatus 1.

### 3. Configuration of Information Processing Apparatus 1

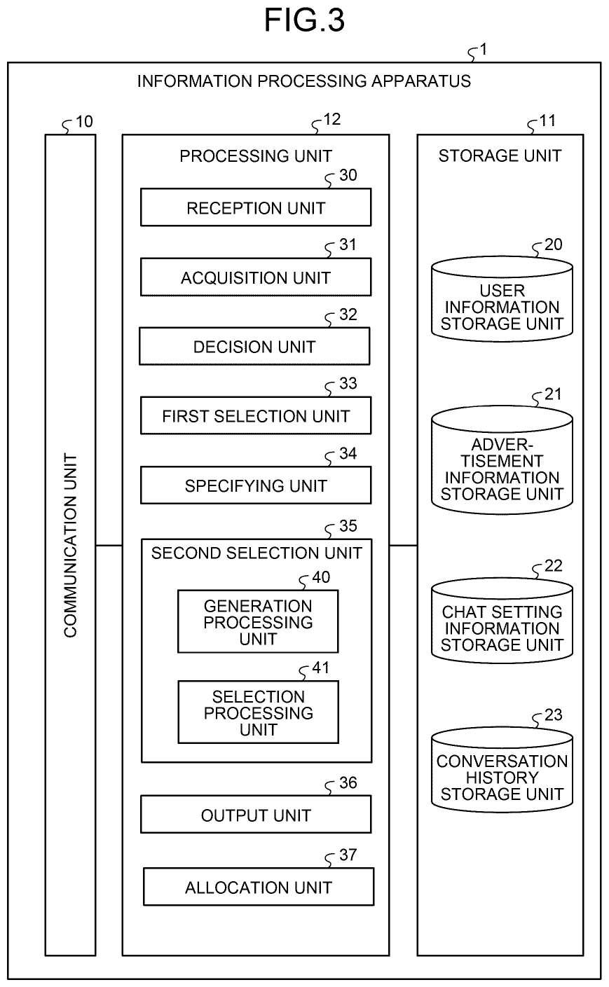

FIG. 3 is a diagram illustrating one example of a configuration of the information processing apparatus 1 according to the embodiment. As illustrated in FIG. 3, the information processing apparatus 1 includes a communication unit 10, a storage unit 11, and a processing unit 12.

### 3.1. Communication Unit 10

The communication unit 10 is implemented by, for example, a communication module, a communication module, a network interface card (NIC), or the like. Furthermore, the communication unit 10 is connected to the network N in a wired or wireless manner, and transmits and receives information to and from the other various devices. For example, the communication unit 10 sends and receives information to and from each of the terminal devices 2 via the network N.

### 3.2. Storage Unit 11

The storage unit 11 is implemented by, for example, a semiconductor memory device, such as a random-access memory (RAM) or a flash memory, or a storage device, such as a hard disk or an optical disk. The storage unit 11 includes a user information storage unit 20, an advertisement information storage unit 21, a chat setting information storage unit 22, and a conversation history storage unit 23.

### 3.2.1. User Information Storage Unit 20

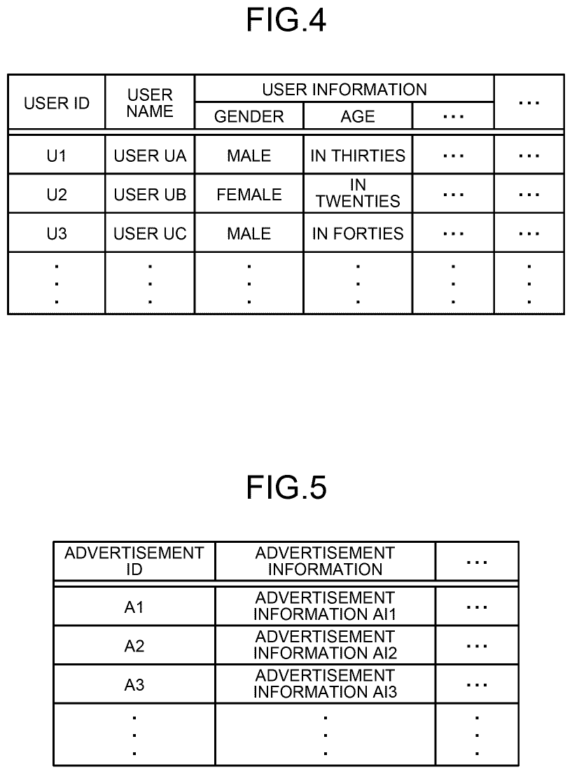

The user information storage unit 20 stores therein user information including the information related to the user U. FIG. 4 is a diagram illustrating one example of a user information table stored in the user information storage unit 20 included in the information processing apparatus 1 according to the embodiment. As illustrated in FIG. 4, the user information table stored in the user information storage unit 20 includes items of “user ID”, “user name”, “user information”, and the like.

The “user ID” is identifier for identifying each of the users U, and is information added to each of the users U. The “user name” is a name of the user U corresponding to the “user ID”. The “user information” is attribute information and a behavior history of the user U associated with the “user ID”.

The attribute information on the user U includes, for example, information on a psychographic attribute, information on a demographic attribute, or the like. The demographic attribute is, for example, gender, age, a place of residence, an occupation, or the like, and the psychographic attribute is a target for interests and concerns, such as travel, clothing, cars, and religions, lifestyles, thought, and tendencies of thought.

The behavior history of the user U is a behavior history of the user U exhibited in the online service and a behavior history of the user U exhibited offline. The behavior history of the user U exhibited in the online service includes information on, for example, a search history, a browsing history, a posting history, a purchase history, and the like.

The search history is information on a search query that was used by the user U in the past, content browsed by the user U from among the search results, or the like. The information on the search query is information on, for example, a search keyword, a search phrase, or the like.

The browsing history includes, for example, information indicating the content that has been browsed by the user U in the online service, and the posting history includes, for example, information indicating the content (for example, a review, a comment, etc.) that was posted by the user U in the past in the online service. The purchase history includes information on a deal target of a deal made by the user U in the past.

The behavior history of the user U exhibited offline is, for example, a movement history of the user U exhibited offline, a usage history of the user U exhibited at a real store (including a purchase history of a product or a service), or the like, but the behavior history is not limited to this example.

### 3.2.2. Advertisement Information Storage Unit 21

The advertisement information storage unit 21 stores therein information related to various kinds of advertisements. FIG. 5 is a diagram illustrating one example of an advertisement information table stored in the advertisement information storage unit 21 included in the information processing apparatus 1 according to the embodiment. As illustrated in FIG. 5, the advertisement information table stored in the advertisement information storage unit 21 includes items of “advertisement ID”, “advertisement information”, and the like.

The “advertisement ID” is an identifier for identifying an advertisement, and is information added to each of the advertisements. The “advertisement information” is various kinds of information related to the advertisement associated with the “advertisement ID”, and includes information on an advertisement, a category of a format of an advertisement, information on a target group, information on a target advertisement, attribute information on each of the advertisements, or the like.

The category of the format of the advertisement is, for example, a banner advertisement, a listing advertisement, a native advertisement, a social media advertisement, a moving image advertisement, or the like, but the category of the format of the advertisement is not limited to this example. The information on the target group is information on the attribute information on the user U targeted for an advertisement to be provided, or the like. The information on a target for an advertisement is, for example, information indicating a category of a service that is a target for an advertisement, a category of a product that is a target for an advertisement, or the like.

In a case where the service targeted for an advertisement is an accommodation service of a hotel, the attribute information on the advertisement is, for example, a site location, a price range, a facility, a service, a room type, a review rating, or the like; in a case where the service that is a target for an advertisement is an accommodation service of a hotel, the attribute information on the advertisement is, for example, a site location, a price range, cuisine, a service, a seat type (for example, a table type, a Japanese-style room), a review rating, or the like, but the attribute information on the advertisement is not limited to this example.

Furthermore, although not illustrated in FIG. 5, the information that is associated with the “advertisement ID” and that indicates advertisement effect target (for example, information on an index that is used to calculate an advertisement effect, etc.) of the advertisement, information on a distribution period of an advertisement, index unit price (for example, Cost Per Action (CPA), etc.), or the like is included in the advertisement information table. Furthermore, the information is not limited to the example described above, and the advertisement information storage unit 21 is able to various kinds of information in accordance with the intended use.

### 3.2.3. Chat Setting Information Storage Unit 22

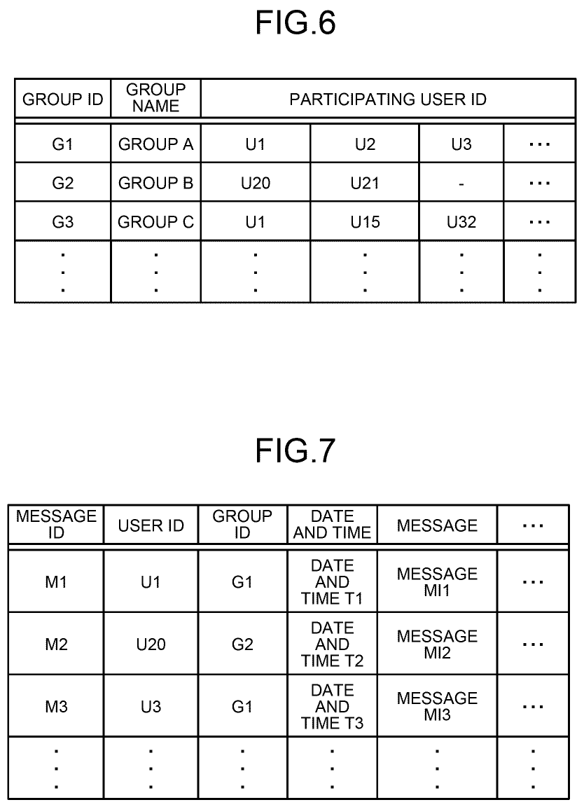

The chat setting information storage unit 22 stores therein various kinds of setting information used in the chat service. FIG. 6 is a diagram illustrating one example of a chat setting information table stored in the chat setting information storage unit 22 included in the information processing apparatus 1 according to the embodiment. As illustrated in FIG. 6, the chat setting information table stored in the chat setting information storage unit 22 includes items of “group ID”, “group name”, “participating user ID”, and the.

The “group ID” is an identifier for identifying a chat group, and is information added to each of the chat groups. The “group name” is information indicating the name of the chat group associated with the “group ID”.

The “participating user ID” includes the user ID of each of the users U participating in the chat group associated with the “group ID”. Furthermore, although not illustrated, as the setting information on other than the chat group, for example, setting information on a chat between one to many, setting information on a chat between one to one, and the like are also included in the chat setting information table illustrated in FIG. 6.

### 3.2.4. Conversation History Storage Unit 23

The conversation history storage unit 23 stores therein various kinds of conversation histories of the chat service. FIG. 7 is a diagram illustrating one example of a conversation history table stored in the conversation history storage unit 23 included in the information processing apparatus 1 according to the embodiment. As illustrated in FIG. 7, the conversation history table stored in the conversation history storage unit 23 includes items of “message ID”, “user ID”, “group ID”, “date and time”, “message”, and the like.

The “message ID” is an identifier for identifying a chat message, and information added to each of the chat messages. The “user ID” is a user ID of the user U who has posted a chat message associated with the “message ID”. The “group ID” is a group ID of the chat group associated with the chat room in which the chat message associated with the “message ID” has been posted.

The “date and time” is information indicating the date and time at which the chat message associated with the “message ID” is posted. The “message” is a chat message associated with the “message ID”. Moreover, although not illustrated, as conversation history other than the chat group, for example, a conversation history of a chat held between one to one, a conversation history of a chat held among one to many, and the like are included in the chat setting information table illustrated in FIG. 7.

### 3.3. Processing Unit 12

The processing unit 12 and is implemented by causing a processor, such as a central processing unit (CPU) or a micro processing unit (MPU), to execute various programs (corresponding to one example of an information processing program) stored in a storage device included in the information processing apparatus 1 by using a RAM or the like as a work area.

Furthermore, the processing unit 12 is a controller (controller), and may be implemented by, for example, an integrated circuit, such as an application specific integrated circuit (ASIC), a field programmable gate array (FPGA), or a general purpose graphic processing unit (GPGPU).

As illustrated in FIG. 3, the processing unit 12 includes a reception unit 30, an acquisition unit 31, a decision unit 32, a first selection unit 33, a specifying unit 34, a second selection unit 35, an output unit 36, and an allocation unit 37, and implements or executes a function or an operation of the information processing that will be described below. Moreover, the internal configuration of the processing unit 12 is not limited to the configuration illustrated in FIG. 3, and may be any other configuration as long as the processing unit 12 is configured to execute information processing that will be described later.

### 3.3.1. Reception Unit 30

The reception unit 30 receives various kinds of requests, information, or the like from the terminal device 2 via the communication unit 10.

For example, the request received by the reception unit 30 is a posting request including a chat message posted by the user U, an acquisition request for a chat message posted by the user U, or the like, but the request is not limited to this example.

The information on the user ID of the user U corresponding to a poster, the group ID of the chat group that is a posting destination, a chat message, and the like is included in the posting request. In a case where the reception unit 30 receives a posting request, the reception unit 30 updates the conversation history table stored in the conversation history storage unit 23 on the basis of the received posting request.

The reception unit 30 is able to receive the posting request including the chat message that has been posted by the user U as an evaluation with respect to the advertisement. The evaluation performed on the advertisement is a negative evaluation represented by the information on, for example, the character string indicating “I would prefer a nicer hotel.”, or a positive evaluation represented by the information on, for example, the character string indicating “I like this hotel.”, but the evaluation performed on the advertisement is not limited to this example. For example, the evaluation with respect to the advertisement may also be performed by selecting a positive evaluation button, a negative evaluation button, or the like that is displayed at a position corresponding to the advertisement.

### 3.3.2. Acquisition Unit 31

The acquisition unit 31 acquires various kinds of information from an external information processing apparatus, the terminal devices 2, or the like via the communication unit 10, and causes the storage unit 11 to store the acquired information.

For example, the acquisition unit 31 acquires user information that is the information on each of the users U from the external information processing apparatus, the terminal devices 2, or the like via the communication unit 10, and adds the acquired user information to the user information table included in the user information storage unit 20. Furthermore, the acquisition unit 31 acquires the advertisement information that is information related to an advertisement, or the like via the communication unit 10, and adds the acquired advertisement information to the advertisement information table included in the advertisement information storage unit 21.

Furthermore, the acquisition unit 31 acquires the user information, the advertisement information, the chat setting information, the conversation history, or the like from the storage unit 11.

### 3.3.3. Decision Unit 32

The decision unit 32 makes various decisions. For example, the decision unit 32 decides, for each chat group, on the basis of the number of users U participating in the group chat, one or more states from among an area size of at least one of the first area and the second area, a display mode (viewing mode) of an advertisement and an output frequency (viewing frequency) of the advertisement. The display mode of the advertisement is a viewing mode of the advertisement that is to be provided to the chat room of the group chat, and is, for example, a text advertisement, a banner advertisement, a pop-up advertisement, or the like, but is not limited to this example.

For example, in a case where the number of users U participating in the group chat is equal to or greater than a threshold, the decision unit 32 uses the display mode of the advertisement as the text advertisement and the banner advertisement, and, if this is not the case, the decision unit 32 uses the display mode of the advertisement as the banner advertisement and does not use the text advertisement. Furthermore, as the number of users U participating in the group chat increases, the decision unit 32 is also able to increase the area size or the output frequency of the advertisement, and is also able to perform the process in an inverse manner.

Furthermore, the decision unit 32 is also able to decide, for each chat group, on the basis of the number of chat message per short time, one or more states from among the area size of at least one of the first area and the second area, the display mode of the advertisement, and the output frequency of the advertisement.

For example, in a case where the number of chat messages per short time is equal to or greater than a threshold, the decision unit 32 uses the display mode of the advertisement as the text advertisement and the banner advertisement, and, if this is not the case, the decision unit 32 uses the display mode of the advertisement as the banner advertisement and does not use the text advertisement. Furthermore, as the number of chat messages per short time increases, the decision unit 32 is also able to increase the area size or the output frequency of the advertisement, and is also able to perform the process in an inverse manner.

Furthermore, the decision unit 32 is also able to decide, for each chat group, on the basis of the number of users U participating in the group chat, one or more states from among the area size of at least one of the first area and the second area, the display mode of the advertisement, and the output frequency of the advertisement.

Furthermore, the decision unit 32 is also able to decide, for each chat group, on the basis of a ratio of premium members participating in the group chat, one or more states from among the area size of at least one of the first area and the second area, the display mode of the advertisement, and the output frequency of the advertisement. The premium member is a member capable of receiving, for example, a specific benefit in a service operated or cosponsored by an operator who provides the chat service, and the user U is able to become a premium member by making a payment of, for example, a fixed monthly fee, or the like.

For example, in a case where the ratio of the premium members participating in the group chat is less than the threshold, the decision unit 32 uses the display mode of the advertisement as the text advertisement and the banner advertisement, and, if this is not the case, the decision unit 32 uses the display mode of the advertisement as the banner advertisement and does not use the text advertisement. Furthermore, as the ratio of the premium members participating in the group chat decreases, the decision unit 32 is also able to increase the area size or the output frequency of the advertisement, and is also able to perform the process in an inverse manner.

Furthermore, in a case where one or more of the number of users U participating in the group chat, the number of chat messages per short time, and the ratio of the premium members participating in the group chat satisfies a predetermined condition, the decision unit 32 is also able to cause the second selection unit 35 to stop the selection of the second advertisement.

The predetermined condition is, for example, a condition that the number of users U participating in the group chat is equal to or less than the threshold, a condition that the number of chat messages per short time is equal to or less than the threshold, and a condition that the ratio of the premium members participating in the group chat is equal to or greater than the threshold, but the condition is not limited to this example.

### 3.3.4. First Selection Unit 33

The first selection unit 33 selects, on the basis of the information on the plurality of users U participating in the group chat, the advertisement to be displayed in the first area of the screen of the group chat as the first advertisement.

For example, the first selection unit 33 selects the first advertisement to be displayed in the first area on the basis of the information on the plurality of users U participating in the group chat and the content of the chat message posted by one of the users U from among the plurality of users U.

The information on the user U is, for example, the attribute information indicating the attribute of the user U or the behavior history. The attribute of the user U is, for example, a demographic attribute, a psychographic attribute, or the like. The demographic attribute is an attribute in terms of a demographic characteristic of the user U. The psychographic attribute is an attribute indicating, for example, interests and concerns of the user U, a sense of values of the user U, a life style of the user U, a personality of the user U, or the like. The behavior history is, for example, a behavior history of each of the users U exhibited online, but may also include a behavior history of each of the users U exhibited offline.

The first selection unit 33 estimates, on the basis of the attribute information on the plurality of users U, the persona exhibited by the chat group to which the plurality of users U belongs. The persona exhibited by the chat group is, for example, a group of three boys who like to travel to Osaka, a group of four girls who love Hokkaido, a volunteer group dedicated to social contribution, a group of a specific game lovers, or the like, but is not limited to this example.

For example, the first selection unit 33 determines, on the basis of the attribute information on the plurality of users U, a characteristic that is common to the plurality of users U as the persona exhibited by the group. The characteristic that is common to the plurality of users U is, for example, the attribute, the interests and concerns, the behavior pattern, or the like, and that is common to the plurality of users U, but is not limited to this example.

The common attribute is, for example, an age group, gender, a family, an occupation, or the like, but is not limited to this example. The common interests and concerns are, for example, a love of cars, love of shopping, a love of travelling, or the like, but is not limited to this example. The common behavior pattern is, for example, traveling once a month, eating out three or more times a weekday evening, go shopping every weekend, or the like, but is not limited to this example.

The first selection unit 33 is able to cause the generative AI to determine the persona exhibited by the group by inputting, for example, the information on the plurality of users U belonging to the group and the instruction information that instructs to determine the persona exhibited by the group from the information on the plurality of users U to the generative AI. In this case, the instruction information is, for example, the information on the character string indicating that “Please determine a persona exhibited by the group of these users based on the given information on the users.”, or the like, but the instruction information is not limited to this example.

Moreover, information indicating an exemplification in which an example of the information on the plurality of users U is associated with an example of the persona exhibited by the group may be included in the instruction information, and, as a result of this, it is possible to cause the generative AI to estimate the persona exhibited by the group with high accuracy. Furthermore, the generative AI may also be generative AI that has been trained by fine-tuning or the like by using a data set of information on the plurality of users U and the persona exhibited by the group, and, in this case, the instruction information does not need to be included in the input information that is input to the generative AI.

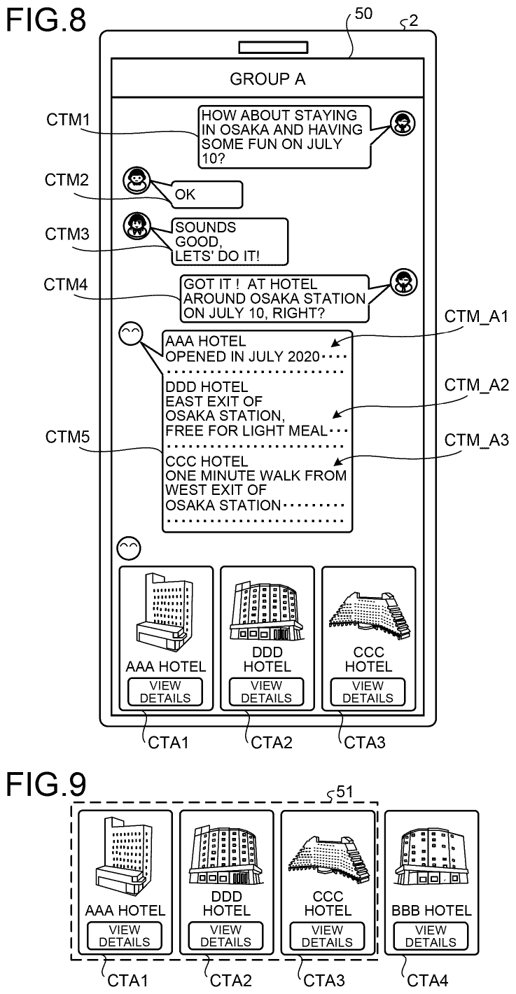

In the example illustrated in FIG. 8 that will be described later, the first selection unit 33 selects the first advertisement on the basis of, for example, the chat message CTM4 that is the latest chat message from among the chat messages CTM1, CTM2, CTM3, and CTM4 exchanged among the user U₁, U₂, and Uₘ and on the basis of the persona exhibited by the group A. The latest chat message CTM4 is the information on the character string indicating that “Got it ˜! At a hotel around Osaka station on July 10, right?”.

The first selection unit 33 uses a natural language processing technique, a regular expression, or the like, and extracts the words of “July 10”, “around Osaka station”, and “hotel” as the information on the specific date, the specific area, and the location type, respectively, from, for example, the chat message CTM4. Furthermore, the first selection unit 33 is also able to extract the information on the specific date, the specific area, and the location type from, for example, the chat message CTM4 by using the generative AI, such as a large language model.

For example, the first selection unit 33 is also able to cause the generative AI to extract the specific date, the specific area, and the location type by inputting, to the generative AI, the chat message CTM4 and the instruction information that instructs to extract the specific date, the specific area, and the location type from the chat message CTM4. In this case, the instruction information is the information on, for example, the character string indicating that “Please extract the date, an area, and a location type from the given message.”, or the like, but the instruction information is not limited to this example.

Moreover, the information indicating an exemplification in which an example of the message is associated with an example of the date, the area, and the location type may also be included in the instruction information, and, as a result of this, it is possible to cause the generative AI to estimate the persona exhibited by the group with high accuracy. Furthermore, the generative AI may also be generative AI that has been trained by fine-tuning or the like by using a data set of the message and the data, and a data set of the area and the location type, and, in this case, the instruction information does not need to be included in the input information that is input to the generative AI.

The first selection unit 33 acquires, from the internal database or the external database, the hotel list that is the list of hotels that are located in a specific area and that are available on a specific date from the information on the specific date, the specific area, the location type, and the like. Furthermore, the first selection unit 33 acquires, from the internal database or the external database, the attribute information (for example, a site location, a price range, a facility, a service, a room type, a review rating, etc.) on each of the hotels included in the hotel list.

The first selection unit 33 selects the first advertisement on the basis of the attribute information on each of the hotels included in the hotel list and the persona exhibited by the group. For example, the first selection unit 33 causes the first learning model to output a score of each of the advertisements by using the first learning model that outputs a score indicating the probability that the advertisement will be selected by using the information that includes both of the attribute information on each of the hotels included in the hotel list and the persona exhibited by the group as input information.

The first selection unit 33 selects, on the basis of the score of each of the advertisements output from the first learning model, the predetermined number of N1 advertisements defined in descending order of scores as the first advertisement. The first learning model is a model of, for example, a logistic regression model, a neural network, or the like, but is not limited to this example.

Moreover, in the example described above, the first selection unit 33 narrows down the location indicated by the location type using the chat message CTM4, but the information processing apparatus 1 is also able to narrow down the location indicated by the location type using the chat message CTM1, or the like. Furthermore, the first selection unit 33 is also able to select the first advertisement on the basis of the persona exhibited by the group without using the chat message CTM4.

Furthermore, the first selection unit 33 reselects the first advertisement on the basis of the plurality of chat messages that have been posted as evaluations of the advertisement performed by the plurality of respective users U. For example, the first selection unit 33 reselects the first advertisement in a case where a predetermined ratio (for example, 50% or above, a ratio of two thirds or more, etc.) of chat messages is a negative evaluation from among the plurality of chat messages that have been posted as evaluations of the advertisement performed by the plurality of respective users U.

The first selection unit 33 determines whether or not the chat message is a negative evaluation on the basis of whether, for example, the term included in a negative term list in which negative terms are listed is included in the chat message, but, for example, the first selection unit 33 is also able to perform the determination by using the generative AI.

For example, the first selection unit 33 is also able to cause the generative AI to output the information indicating a determination result implying whether or not to reselect an advertisement by inputting the information that includes both of the plurality of chat messages that have been posted as evaluations of the advertisement performed by the plurality of respective users U and the instruction information that instructs to determine whether or not an advertisement is to be reselected to the generative AI as input information.

### 3.3.5. Specifying Unit 34

The specifying unit 34 specifies various kinds of items. For example, the specifying unit 34 specifies a chat message that has been posted by the user U in another chat room that is other than the chat room of the group chat and specifies the other party of the chat message to be notified.

For example, it is assumed that the user U₁ participates in the group chats for the groups A and B, and the users Uₘ₊₁ and Uₘ₊₂ participate in the group chat for the group B. In this case, the specifying unit 34 specifies the chat message that has been posted by the user U₁ in the chat room of the group chat for the group B and specifies the users Uₘ₊₁ and Uₘ₊₂ who are the other parties of the chat message to be notified.

Furthermore, the specifying unit 34 specifies the other chat room in which the user U participates, on the basis of the chat message that has been posted by the user U in the chat room of the group chat. For example, it is assumed that the user U₁ is participating in the group chats for the groups A, B, and C. The specifying unit 34 specifies, on the basis of the chat message posted by the user U₁ in the chat room of the group A, the other chat room in which the chat message correlated with the chat message has been posted as a correlation chat room between the chat rooms of the groups B and C.

For example, the specifying unit 34 has a correlation term list in which the terms that are correlated with each other are listed, and is able to specify, as the correlation chat room, the other chat room, in which a chat message that includes a term correlated with the term included in the chat message posted by the user U₁ in the chat room of the group A has been posted, and in which the user U₁ participates.

For example, the specifying unit 34 is also able to specify, as the correlation chat room, the other chat room in which the chat message has been posted by the user U₁ immediately before the post of the chat message performed by the user U₁ in the chat room of the group A.

Furthermore, the specifying unit 34 is also able to specify the correlation chat room by using the generative AI. For example, the specifying unit 34 is also able to cause the generative AI to output the information indicating the correlation chat room by inputting, to the generative AI, the information including both of the chat messages exchanged in the other chat room in which the user U is participating and the instruction information that instructs to specify the correlation chat room.

The instruction information includes, for example, information indicating a condition that the other chat room, in which the chat message correlated with the chat message has been posted by the user U₁ who is the same user U₁ belonging to the chat room of the group A, is specified as the correlation chat room. Furthermore, the instruction information includes, for example, definition information indicating that the chat room in which a common topic (for example, a topic addressed by the other user U₂, . . . , and Uₘ who are participating in the chat room of the group A) has been posted is defined as the correlation chat room, but the instruction information is not limited to this example.

Moreover, in the instruction information, information indicating an exemplification in which an example of a chat message exchanged in a certain chat room is associated with an example of a chat message exchanged in the correlation chat room may also be included, and, as a result of this, it is possible to cause the generative AI to specify the correlation chat room with high accuracy.

### 3.3.6. Second Selection Unit 35

The second selection unit 35 selects, on the basis of the history of the conversations held by the users U in the group chat, the advertisement that is to be displayed in the second area of the screen of the group chat as the second advertisement.

For example, the second selection unit 35 selects the second advertisement on the basis of the content of the chat message that has been posted by one of the users from among the plurality of users U and on the basis of the history of the conversations held by the users U in the group chat before the chat message has been posted.

The chat message posted by one of the users U from among the plurality of users U is the latest chat message that has been posted in the chat room of the group chat, but is not limited to this example. Moreover, the second advertisement is selected by the second selection unit 35 from an advertisement group corresponding to a selection candidate for the first advertisement selected by the first selection unit 33, but is not limited to this example. For example, the second advertisement may also be selected from an advertisement group that is other than the advertisement group corresponding to the selection candidate for the first advertisement selected by the first selection unit 33.

The second selection unit 35 includes a generation processing unit 40 that causes the generative AI to generate advertisement condition information indicating the condition for the advertisement to be displayed in the second area, and a selection processing unit 41 that selects the second advertisement on the basis of the advertisement condition information that has been generated by the generation processing unit 40.

### 3.3.6.1. Generation Processing Unit 40

The generation processing unit 40 causes the generative AI to generate the advertisement condition information indicating the condition for the advertisement to be displayed in the second area. For example, the generation processing unit 40 causes the generative AI to generate the advertisement condition information indicating the second advertisement condition that is the condition for the advertisement to be displayed in the second area by inputting the information on the history of the conversations held by the users U to the generative AI as input information.

The second advertisement condition is a condition that is used at the time of selection of the second advertisement to be provided to the group. For example, the second advertisement condition includes a condition for defining a category targeted for an advertisement (for example, a category of a service targeted for an advertisement or a category of a product targeted for an advertisement), a target group (age, gender, an occupation, interests and concerns, etc.), a category of a format of an advertisement (for example, a moving image advertisement, a banner advertisement, a native advertisement, etc.), or the like.

The category of the service is, for example, an accommodation service provided by a hotel, a food and beverage service provided by an eating house, a catering service provided by an eating house, or the like, but the category of the service is not limited to this example. In a case where the category targeted for the advertisement is a hotel, the second advertisement condition is able to include a condition for the date of use, an area, the number of persons staying, or the like. Furthermore, in a case where the category targeted for the advertisement is an eating house, the second advertisement condition is able to include a condition of date and time of use, a genre of an eating house, an area, the number of persons dining, or the like.

The generative AI is, for example, text generative AI. The text generative AI is a large language model that has been trained, for example, to estimate and output a subsequent token from an input token string, and is, for example, a transformer based model, a RNN based model, or the like. The transformer based model is, for example, a GPT, or the like, but is not limited to this example. The RNN based model is, for example, a RWKV, or the like, but is not limited to this example.

Moreover, the generative AI may be a language model that has been dedicatedly trained (for example, fine-tuning) to generate reply information. The generative AI is arranged in an external information processing apparatus, and the generation processing unit 40 uses the generative AI via an API, but the generative AI may also be arranged in the information processing apparatus 1.

The generation processing unit 40 causes the generative AI to generate the advertisement condition information indicating the second advertisement condition that is the condition for the advertisement to be displayed in the second area by inputting the information including, for example, both of the history of the conversations held among the users U and the instruction information that is information on the character string indicating that “Please specify a condition for the advertisement to be suggested to the user group having a given conversation.” to the generative AI as input information.

Moreover, the information indicating an exemplification in which an example of the history of the conversations is associated with a condition example of the advertisement to be suggested may also be included in the instruction information, and, as a result of this, it is possible to cause the generative AI to generate the advertisement condition information with high accuracy. Furthermore, the generative AI may also be generative AI that has been trained by fine-tuning or the like by using a data set of the history of the conversations held among the plurality of users U and the advertisement condition information, and, in this case, the instruction information does not need to be included in the input information that is input to the generative AI.

Furthermore, the generation processing unit 40 is also able to cause the generative AI to generate the advertisement condition information indicating the condition for the advertisement to be displayed in the second area by inputting the information that includes both of the information on the plurality of users U and the history of the conversations held among the users U to the generative AI as input information. The information on each of the users U is, for example, the attribute information, the behavior history, or the like. For example, the generation processing unit 40 causes the generative AI to generate the advertisement condition information by inputting the information including the information on the plurality of users U, the history of the conversations held among the users U, and the instruction information to the generative AI as input information.

In this case, the instruction information is the information on, for example, the character string indicating that “Please specify a condition for the advertisement to be suggested to the group of the plurality of users each having the given attribute and each having the given conversation.”, but the instruction information is not limited to this example. In this case, also, information or the like indicating an exemplification in which a combination example of the information on the plurality of users U and the history of the conversations is associated with a condition example of the advertisement to be suggested, or the like may also be included in the instruction information.

Furthermore, the generation processing unit 40 is also able to cause the generative AI to generate the advertisement condition information by inputting the information including the information on the plurality of users U, the content of the chat message posted by one of the users U from among the plurality of users U, and the history of the conversations held among the users U in the chat room of the group chat before posting of the chat message to the generative AI as input information.

For example, the generation processing unit 40 causes the generative AI to generate the advertisement condition information by inputting the information including the information on the plurality of users U, the content of the chat message posted by the user U, the history of the conversations held among the users U in the chat room of the group chat before posting of the chat message, and the instruction information to the generative AI as input information.

In this case, the instruction information is, for example, information on a character string indicating that “Please specify a condition for the advertisement to be suggested to the group of the plurality of users each having the given attribute and each are having the given conversations. For the condition for the advertisement to be suggested, please place the most importance on the latest message.”, but the instruction information is not limited to this example.

In this case, also, the information indicating an exemplification in which a combination example of the information on the plurality of users U, the history of the conversations, and the latest message is associated with a condition example of the advertisement to be suggested, or the like may also be included in the instruction information. The latest message is the latest chat message from among the plurality of chat messages included in the input information.

Furthermore, the generation processing unit 40 causes the generative AI to generate the base information that is the information indicating the base of the second advertisement condition indicated by the advertisement condition information and that is the information displayed on the screen of the group chat by inputting the information including the information that instructs to generate the base of the second advertisement condition indicated by the advertisement condition information to the generative AI as input information.

The generation processing unit 40 is able to cause the generative AI to generate the information indicating the base of the second advertisement condition indicated by the advertisement condition information by further including the information on, for example, the character string indicating that “Furthermore, please output a sentence indicating the base for specifying the condition for the advertisement.” to the above described instruction information. The generation processing unit 40 is able to enhance the accuracy of the condition for the second advertisement specified by the generative AI by causing the generative AI to output the information indicating the base for specifying the condition for the second advertisement.

The base information is the information on, for example, information on the character string indicating that “Because we are looking for a hotel around Osaka station”, information on the character string indicating that “Because we are so excited about our trip to Okinawa”, or the like, but the base information is not limited to this example.

Moreover, the base information may also include the information indicating a summary of the history of the conversations that are used to select the second advertisement. In this case, in the base information generated by the generation processing unit 40, the information on the character string indicating that “The above described advertisement is displayed for the following reason.” is included.

### 3.3.6.2. Selection Processing Unit 41

The selection processing unit 41 selects the second advertisement on the basis of the advertisement condition information that has been generated by the generation processing unit 40.

For example, in a case where the information (for example, the information on the accommodation date and time, the accommodation area, etc.) related to the accommodation service is included in the advertisement condition information that has been generated in the manner described above, the selection processing unit 41 acquires, from the internal database or the external database, the hotel list that is a list of the hotels that are located in the accommodation area and that are available on the accommodation date and time from the information related to the accommodation service. Furthermore, the selection processing unit 41 acquires, from the internal database or the external database, the attribute information (for example, a site location, a price range, a facility, a service, a room type, a review rating, etc.) on each of the hotels included in the hotel list.

The selection processing unit 41 selects the first advertisement on the basis of the attribute information on each of the hotels included in the hotel list and the persona exhibited by the group A. For example, the selection processing unit 41 causes the second learning model to output a score of each of the advertisements by using the second learning model that outputs a score indicating the probability that the advertisement will be selected by using the information that includes both of the attribute information on each of the hotels included in the hotel list and the information (a target group, information on a category of a format of an advertisement, etc.) included in the advertisement condition information that has been generated as described above as input information.

The selection processing unit 41 selects, on the basis of the score of each of the advertisements output from the second learning model, the predetermined number of N2 advertisements defined in descending order of scores as the second advertisement. The second learning model is a model of, for example, a logistic regression model, a neural network, or the like, but is not limited to this example.

The second selection unit 35 reselects the second advertisement on the basis of the plurality of chat messages that have been posted as evaluations performed on the second advertisement by the plurality of users U. The second selection unit 35 determines whether or not the chat message is a negative evaluation on the basis of whether, for example, the term included in a negative term list in which negative terms are listed is included in the chat message, but, for example, the second selection unit 35 is also able to perform the determination by using the generative AI.

For example, the second selection unit 35 is also able to cause the generative AI to output the information indicating a determination result implying whether or not to reselect an advertisement by inputting the information that includes both of the plurality of chat messages that have been posted as evaluations of the advertisement performed by the plurality of respective users U and the instruction information that instructs to determine whether or not an advertisement is to be reselected to the generative AI as input information.

Furthermore, the second selection unit 35 is able to select the second advertisement that is to be displayed in the second area on the basis of the history of the conversations held among the users, the chat message specified by the specifying unit 34, and the other party of the chat message to be notified.

For example, the second selection unit 35 narrows down the category or the content of the second advertisement on the basis of the chat message specified by the specifying unit 34. For example, the second selection unit 35 specifies information on the specific date, the specific area, the location type, or the like on the basis of the chat message specified by the specifying unit 34.

For example, the second selection unit 35 uses a natural language processing technique, a regular expression, or the like, and extracts information on the specific date, the specific area, the location type, or the like from both of the latest message that has been posted in the chat room and the chat message of the correlation chat room specified by the specifying unit 34. Furthermore, the second selection unit 35, the specifying unit 34 is also able to change the priority of the advertisement to be selected on the basis of the specified by the other party of the chat message to be notified.

### 3.3.7. Output Unit 36

The output unit 36 outputs the first advertisement that has been selected by the first selection unit 33 and the second advertisement that has been selected by the second selection unit 35.

For example, the output unit 36 outputs the first advertisement and the second advertisement by sending the first advertisement selected by the first selection unit 33 and the second advertisement selected by the second selection unit 35 to the plurality of terminal devices 2 that are used by the plurality of respective users U belonging to the chat group via the communication unit 10.

Furthermore, the output unit 36 is also able to output the base information that has been generated by the generation processing unit 40 included in the second selection unit 35 to the terminal devices 2. For example, the output unit 36 outputs the base information to the plurality of terminal devices 2 after the output unit 36 has output the first advertisement and the second advertisement to the plurality of terminal devices 2 that are used by the plurality of respective users U belonging to the chat group or before the first advertisement and the second advertisement are displayed.

FIG. 8 is a diagram illustrating one example of a screen of the group chat that is displayed on the terminal device 2 and that includes the first advertisement and the second advertisement that are output by the output unit 36 included in the processing unit 12 in the information processing apparatus 1 according to the embodiment.

As illustrated in FIG. 8, the chat messages CTM1, CTM2, CTM3, CTM4, and CTM5, and the advertisements CTA1, CTA2, and CTA3 are displayed on a group chat screen 50 that is the screen of the group chat.

The chat messages CTM1 and CTM4 are chat messages that are posted by the user U₁, the chat message CTM2 is a chat message posted by, for example, the user U₂, and the chat message CTM3 is a chat message posted by, for example, the user Uₘ.

The chat message CTM5 is a chat message generated by the information processing apparatus 1, and includes an advertisement CTM_A1, an advertisement CTM_A2, and an advertisement CTM_A3 that are text advertisements. Furthermore, the advertisements CTA1, CTA2, and CTA3 are banner advertisements in which an image, a text, and a link are included, and is advertisement that is displayed as a carousel display, and are accordingly referred to as card advertisements.

The advertisement CTA1, the advertisement CTA2, the advertisement CTM_A1, and the advertisement CTM_A2 are the first advertisements, whereas the advertisement CTA3 and the advertisement CTM_A3 are the second advertisement. The advertisement CTA1 and the advertisement CTM_A1 are advertisements for the AAA hotel, the advertisement CTA2 and the advertisement CTM_A2 are advertisements for the DDD hotel, and the advertisement CTA3 and the advertisement CTM_A3 are advertisements for the CCC hotel.

The advertisement CTM_A1 and the advertisement CTA1 are the advertisements for the same AAA hotel, the advertisement CTA1 includes an explanatory text about the AAA hotel, and the advertisement CTA1 includes link information in addition to the image and the name of the AAA hotel. The user U is able to cause the terminal device 2 to display a landing page of the AAA hotel by operating the terminal device 2 and selecting the advertisement CTA1.

Both of the advertisement CTM_A2 and the advertisement CTA2 are the advertisements for the same DDD hotel, the advertisement CTA2 includes an explanatory text about the DDD hotel, and the advertisement CTA2 includes link information in addition to the image and the name of the DDD hotel. The user U is able to cause the terminal device 2 to display a landing page of the DDD hotel by operating the terminal device 2 and selecting the advertisement CTA2.

Both of the advertisement CTM_A3 and the advertisement CTA3 are the advertisements for the same CCC hotel, the advertisement CTA3 includes an explanatory text about the CCC hotel, the advertisement CTA2 includes link information in addition to the image and the name of the CCC hotel. The user U is able to cause the terminal device 2 to display a landing page of the CCC hotel by operating the terminal device 2 and selecting the advertisement CTA3.

Furthermore, the advertisement CTA4 (not illustrated) or the like is also included in the second advertisement that is provided to the terminal device 2 by the output unit 36 in an area that is positioned outside the display area of the terminal device 2. FIG. 9 is a diagram illustrating one example of the first advertisement and the second advertisement that is output by the output unit 36 included in the processing unit 12 in the information processing apparatus 1 according to the embodiment and that is displayed as a carousel display.

In the example illustrated in FIG. 9, the advertisements CTA1, CTA2, CTA3, and CTA4 are included in the first advertisement and the second advertisement that are output by the output unit 36 and that are displayed as a carousel display. The advertisements CTA1 and CTA2 are the first advertisement, and are displayed, in the initial state, at a top position located on the leftmost side and at the second position, respectively, whereas the advertisements CTA3 and CTA4 are the second advertisement, and are arranged at a position that corresponds to a lower level that is located on the right side of the first advertisement. The advertisement CTA4 is located, in the initial state, outside a display area 51 of the terminal device 2. Moreover, in the initial state, the number of second advertisements arranged outside the display area 51 of the terminal device 2 is not limited to one.

The advertisements CTA1, CTA2, CTA3, and CTA4 are moved in an array direction in accordance with an operation performed by the user U (for example, a swipe operation, a scroll operation, etc.) and are displayed as a carousel display. Furthermore, the advertisements CTA1, CTA2, CTA3, and CTA4 may also be displayed as a carousel display in which the advertisements CTA1, CTA2, CTA3, and CTA4 are displayed by being shifted one by one in a rotating sequence at a fixed interval after the display in the initial state has been started.

In this way, the first area and the second area are arrayed in a direction (in the horizontal direction in FIG. 8) perpendicular to an array direction (in the vertical direction in FIG. 8) of the chat messages displayed on the group chat screen 50. Then, in an area including the first area and the second area, the advertisements CTA1, CTA2, CTA3, and CTA4 are displayed as a carousel display.

Moreover, each of the advertisements CTM_A1, CTM_A2, and CTM_A3 is a text advertisement that is an advertisement formed in a message format, and is displayed in the same display mode as that of the chat message in the group chat displayed on the screen. Moreover, in the example illustrated in FIG. 8, each of the advertisements CTM_A1, CTM_A2, and CTM_A3 does not include a link to the landing page, but is able to include the link to the landing page.

Each of the advertisements CTA1, CTA2, CTA3, and CTA4 is a banner advertisement that includes an image, a text, and a link, and is an advertisement that is displayed as a carousel display, so that the advertisements CTA1, CTA2, CTA3, and CTA4 are also referred to as card advertisements.

In a case where the advertisement displayed as a carousel display in the display area 51 has been changed, the output unit 36 is able to output a request to change the content of the chat message CTM5 to the terminal device 2 such that the text advertisement corresponding to the advertisement displayed in the display area 51 is included in the chat message CTM5. As a result of this, it is possible to prevent an advertisement other than the text advertisement corresponding to the advertisement displayed in the display area 51 from being included as the content of the chat message CTM5.

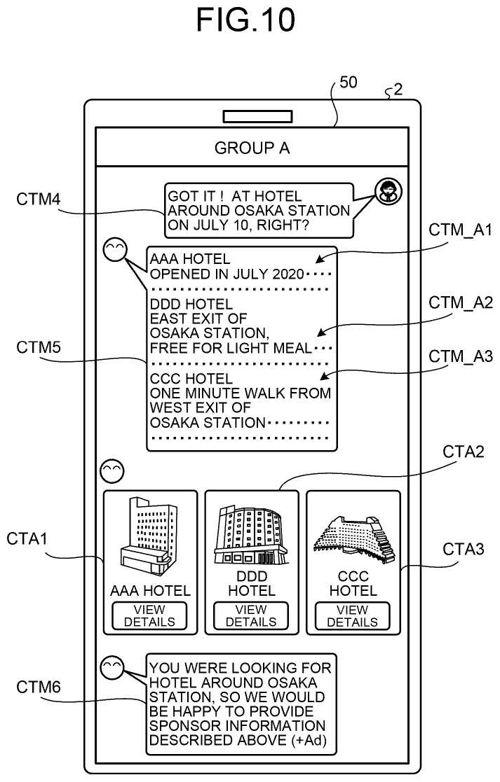

FIG. 10 is a diagram illustrating one example of a screen of a group chat that is displayed on the terminal device 2 and that includes the first advertisement, the second advertisement, and the base information that are output by the output unit 36 included in the processing unit 12 in the information processing apparatus 1 according to the embodiment.

On the group chat screen 50 illustrated in FIG. 10, a chat message CTM6 including the base information is subsequently displayed below the advertisements CTM_A1, CTM_A2, CTM_A3, CTA1, CTA2, CTA3, and CTA4.

The base information included in the chat message CTM6 is information on the character string indicating that “You were looking for a hotel around Osaka station, so we would be happy to provide the sponsor information described above (+Ad)”, and, as a result of this, the user U of the chat group is able to easily figure out the reason that the advertisements CTM_A1, CTM_A2, CTM_A3, CTA1, CTA2, CTA3, and CTA4 are displayed. As a result of this, the information processing apparatus 1 is able to enhance an advertising effect of the advertisements CTM_A1, CTM_A2, CTM_A3, CTA1, CTA2, CTA3, and CTA4.

### 3.3.8. Allocation Unit 37

The allocation unit 37 allocates an advertisement rate of the advertisement displayed on the screen of the chat message as the source of a usage fee for the generative AI. As a result of this, the information processing apparatus 1 is able to provide the chat service using the generative AI without imposing the usage fee for the generative AI on the user U.

Moreover, in a case where it is not possible to completely apply the advertisement rate of the advertisement displayed on the screen of the chat message to the source of the usage fee for the generative AI, the allocation unit 37 is also able to allocate a payment of the difference to the user U.

### 4. Processing Procedure

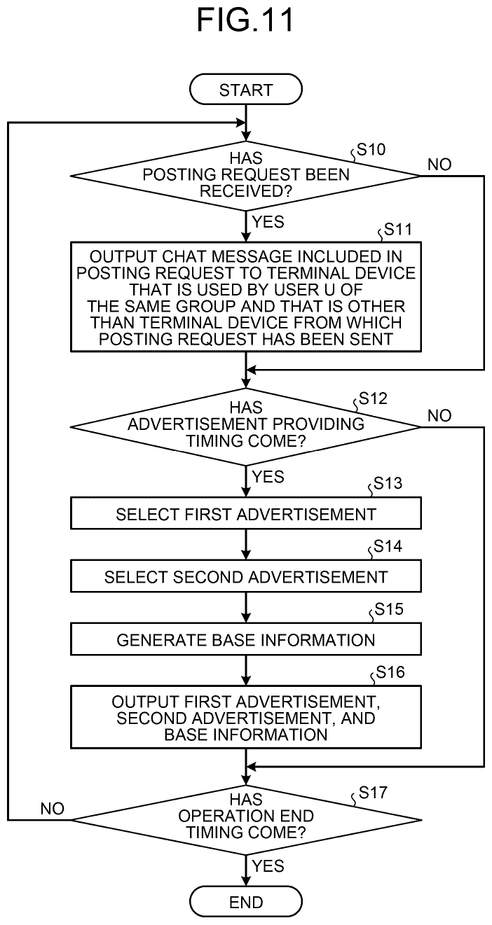

In the following, a procedure of information processing performed by the processing unit 12 included in the information processing apparatus 1 according to the embodiment will be described. FIG. 11 is a flowchart illustrating one example of the information processing performed by the processing unit 12 included in the information processing apparatus 1 according to the embodiment.

As illustrated in FIG. 11, the processing unit 12 included in the information processing apparatus 1 determines whether or not a posting request has been received (Step S10). If the processing unit 12 determines that the posting request has been received (Yes at Step S10), the processing unit 12 outputs the chat message included in the posting request to the terminal device 2 that is used by the user U of the same group and that is other than the terminal device 2 from which the posting request has been sent (Step S11).

If the process at Step S11 has been ended, or if the processing unit 12 determines that the posting request is not received (No at Step S10), the processing unit 12 determines whether or not an advertisement providing timing has come (Step S12). The advertisement providing timing is, for example, a timing at which it is determined by the processing unit 12 that an effective advertisement is able to be provided on the basis of the content of the posted chat message, or a predetermined timing, but the advertisement providing timing is not limited to this example.

If the processing unit 12 determines that the advertisement providing timing has come (Yes at Step S12), the processing unit 12 selects, on the basis of the information on the plurality of users U participating in the group chat, the advertisement to be displayed in the first area of the screen of the group chat as the first advertisement (Step S13).

Furthermore, the processing unit 12 selects, on the basis of the history of the conversations held among the users U of the group chat, the advertisement to be displayed in the second area of the screen of the group chat as the second advertisement (Step S14). Furthermore, the processing unit 12 generates the base information that is the information indicating the base of a condition for a selection of the second advertisement (Step S15).

Subsequently, the processing unit 12 outputs the first advertisement selected at Step S13, the second advertisement selected at Step S14, and the base information generated at Step S15 to the terminal device 2 of each of the users U of the group chat (Step S16).

If the processing unit 12 has ended the process at Step S16, or if the processing unit 12 determines that the advertisement providing timing has not yet come (No at Step S12), the processing unit 12 determines whether or not an operation end timing has come (Step S17). The processing unit 12 determines that the operation end timing has come in a case where, for example, a power supply of the information processing apparatus 1 is turned off, or the like.

If the processing unit 12 determines that the operation end timing has not yet come (No at Step S17), the process proceeds to Step S10, and, if the processing unit 12 determines that the operation end timing has come (Yes at Step S17), the processing unit 12 ends the process illustrated in FIG. 11.

### 5. Modification

In the example described above, the description has been made on the assumption that the generative AI is the text generative AI, but the example is not limited to this, and the generative AI may also be, for example, multimodal generative AI, or the like. The multimodal generative AI is generative AI capable of generating, for example, a text and an image from the text, the image, and the like.

The second selection unit 35 is also able to cause the generative AI to generate advertisement condition information that indicates the second advertisement condition from the history of the conversations including images and stamps by using the multimodal generative AI. The multimodal generative AI is, for example, GPT-4 Turbo with vision, gemini, CM3Leon (Chameleon Multimodal Model), or the like, but is not limited to this example.

Furthermore, the generation processing unit 40 included in the second selection unit 35 is also able to estimate a situation of the group of the chat room by using the generative AI on the basis of the history of the conversations held among the plurality of users U in the chat room.

The generation processing unit 40 causes the generative AI to estimate a situation of the group in the chat room by inputting the information including, for example, the history of the conversations held among the plurality of users U in the chat room and the instruction information that instructs to estimate the situation of the group to the generative AI as input information.

The instruction information includes both of the information on, for example, the character string indicating that “The given message history is a history of the conversations held among the plurality of users U in the chat room. Please estimate a situation of the group in the chat room based on the history of these conversations. The situation is defined as follows.”, and the definition information on the situation.

Moreover, information indicating an exemplification in which an example of a conversation is associated with an example of a situation may also be included in the instruction information, and, as a result of this, it is possible to cause the generative AI to estimate the situation with high accuracy. Furthermore, the generative AI may also be generative AI that has been trained by fine-tuning or the like by using a data set of the conversations held by the plurality of users U and the situation, and, in this case, the instruction information does not need to be included in the input information that is input to the generative AI.

The generation processing unit 40 is also able to cause the generative AI to generate the advertisement condition information indicating the second advertisement condition on the basis of the estimated situation of the group. The situation of the group is a category of a topic discussed in a group, a depth of the topic discussed in the group, an atmosphere of the group, a hierarchical relationship among the users U in the group, a degree of intimacy in the group, a level of humor, or the like, but the situation of the group is not limited to this example.

For example, the generation processing unit 40 causes the generative AI to generate the advertisement condition information indicating the second advertisement condition that is the condition for the advertisement to be displayed in the second area by inputting the information including both of the situation of the group and the instruction information that instructs to generate the advertisement condition information indicating the second advertisement condition to the generative AI as input information. The instruction information is information on, for example, the character string indicating that “Please specify a condition for the advertisement to be suggested to the group that is in the given situation.”, or the like, but the instruction information is not limited to this example. Furthermore, the definition information on the situation may also be included in the instruction information.

Furthermore, the output unit 36 is also able to provide the second advertisement by limiting to, for example, some of the users U from among the plurality of users U belonging to the group, or provide the second advertisement in a different mode for each user U. For example, the output unit 36 provides the second advertisement by limiting to the top k users U in the chat room of the chat group in descending order of chat messages posted by the user U. k is the number of users U account for x % (x is, for example, 50) of the total number of users U in the group, but the number of users U is not limited to this example.

### 6. Hardware Configuration

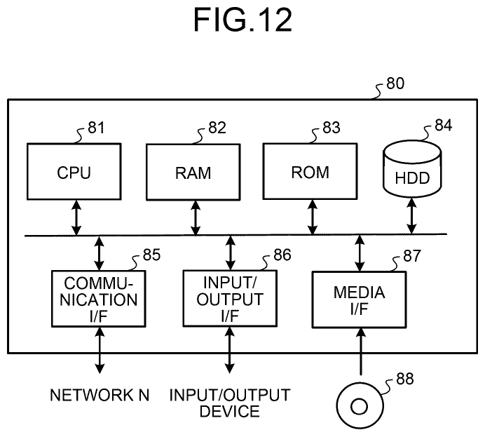

The information processing apparatus 1 according to the embodiment described above is implemented by a computer 80 having a configuration illustrated in, for example FIG. 12. FIG. 12 is a diagram of a hardware configuration illustrating one example of the computer 80 that implements a function of the information processing apparatus 1 according to the embodiment. The computer 80 includes a CPU 81, a RAM 82, a read only memory (ROM) 83, a hard disk drive (HDD) 84, a communication interface (I/F) 85, an input/output interface (I/F) 86, and a media interface (I/F) 87.

The CPU 81 operates based on a program stored in the ROM 83 or the HDD 84, and performs control of each of the units. The ROM 83 stores therein a boot program executed by the CPU 81 at the time of the startup of the computer 80, a program dependent on the hardware of the computer 80, and the like.

The HDD 84 stores therein a program executed by the CPU 81, data that is used by the program, and the like. The communication interface 85 receives data from another device via the network N (see FIG. 2), sends the data to the CPU 81, and transmits the data generated by the CPU 81 to the other devices via the network N.

The CPU 81 controls, via the input/output interface 86, output devices, such as a display and a printer, and input devices, such as a keyboard and a mouse. The CPU 81 acquires data from the input device via the input/output interface 86. Furthermore, the CPU 81 outputs the generated data to the output device via the input/output interface 86.

The media interface 87 reads a program or data stored in a recording medium 88, and provides the program or the data to the CPU 81 via the RAM 82. The CPU 81 loads the program into the RAM 82 from the recording medium 88 via the media interface 87, and executes the loaded program. The recording medium 88 is, for example, an optical recording medium, such as a digital versatile disc (DVD) or a phase change rewritable disk (PD); a magneto optical recording medium, such as a magneto-optical disk (MO); a tape medium; a magnetic recording medium; a semiconductor memory; or the like.

For example, in a case where the computer 80 functions as the information processing apparatus 1 according to the embodiment, the CPU 81 included in the computer 80 implements the function of the processing unit 12 by executing the program loaded into the RAM 82. Furthermore, the HDD 84 stores therein data stored in the storage unit 11. The CPU 81 included in the computer 80 reads and executes the programs from the recording medium 88, but, as another example, the CPU 81 may also acquire the programs from the other device via the network N.

### 7. Others

Of the processes described in the embodiment, all or a part of the processes that are mentioned as being automatically performed may also be manually performed, or, alternatively, the all or a part of the processes that are mentioned as being manually performed may also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

Furthermore, the components of each unit illustrated in the drawings are only for conceptually illustrating the functions thereof and are not always physically configured as illustrated in the drawings. In other words, the specific shape of a separate or integrated unit is not limited to the drawings; however, all or part of the unit can be configured by functionally or physically separating or integrating any of the units depending on various kinds of loads or use conditions.

For example, the information processing apparatus 1 described above may be implemented by a terminal device and a server computer, or may be implemented by a plurality of server computers, or, alternatively, the configuration may be flexibly changed by calling an external platform or the like by using an API, network computing, or the like depending on the function.

Furthermore, the processes described in the embodiment may appropriately be combined as long as the processes do not conflict with each other.

### 8. Effects

As described above, the information processing apparatus 1 according to the embodiment includes the first selection unit 33, the second selection unit 35, and the output unit 36. The first selection unit 33 selects, on the basis of the information on the plurality of users U participating in the group chat, the advertisement to be displayed in the first area of the screen of the group chat. The second selection unit 35 selects, on the basis of the history of the conversations held among the users U of the group chat, the advertisement to be displayed in the second area of the screen of the group chat. The output unit 36 outputs the advertisement selected by the first selection unit 33 and the advertisement selected by the second selection unit 35. As a result of this, the information processing apparatus 1 is able to improve selectivity of the advertisements displayed in the chat room of the group chat.

Furthermore, the second selection unit 35 includes the generation processing unit 40 that causes the generative AI to generate the advertisement condition information indicating the condition for the advertisement to be displayed in the second area by inputting the information including the history of the conversations held among the users U to the generative AI as input information, and the selection processing unit 41 that selects the advertisement to be displayed in the second area on the basis of the advertisement condition information generated by the generation processing unit 40. As a result of this, the information processing apparatus 1 is able to select the advertisement specified by the condition indicated by the advertisement condition information with high accuracy.

Furthermore, the generation processing unit 40 causes the generative AI to generate the advertisement condition information indicating the condition for the advertisement to be displayed in the second area by inputting the information including the information on the plurality of users U and the history of the conversations held among the users U to the generative AI as input information. As a result of this, the information processing apparatus 1 is able to select the advertisement specified by the condition indicated by the advertisement condition information with high accuracy.

Furthermore, the generation processing unit 40 causes the generative AI to generate the base information that is the information indicating the base of the condition indicated by the advertisement condition information and that is displayed on the screen of the group chat by inputting the information including the information that instructs to generate the base of the condition indicated by the advertisement condition information to the generative AI as input information, and the output unit 36 outputs the base information generated by the generation processing unit 40. As a result of this, the information processing apparatus 1 is able to allow the user U to easily figure out a selection reason for the advertisement displayed in the second area.

Furthermore, the second selection unit 35 selects the advertisement displayed in the second area on the basis of the content of the chat message post by one of the users U from among the plurality of users U and on the basis of the history of the conversations held among the users U in the group chat before the chat message is posted. As a result of this, the information processing apparatus 1 is able to improve selectivity of the advertisements displayed in the chat room of the group chat.

Furthermore, the information processing apparatus 1 further includes the specifying unit 34 that specifies the chat message that has been posted by the user U in another chat room that is other than the chat room of the group chat, and the second selection unit 35 selects the advertisement displayed in the second area on the basis of the history of the conversation held among the users U and on the basis of the chat message specified by the specifying unit 34. As a result of this, the information processing apparatus 1 is able to improve selectivity of the advertisements displayed in the chat room of the group chat.

Furthermore, the specifying unit 34 specifies another chat room on the basis of the chat message posted by the user U in the chat room of the group chat. As a result of this, the information processing apparatus 1 is able to improve selectivity of the advertisements displayed in the chat room of the group chat.

Furthermore, the first selection unit 33 selects the advertisement displayed in the first area on the basis of the information on the plurality of users U participating in the group chat and on the basis of the content of the chat message posted by one of the users U from among the plurality of users U. As a result of this, the information processing apparatus 1 is able to improve selectivity of the advertisements displayed in the chat room of the group chat.

Furthermore, the advertisements are displayed, in the first area and the second area, in the same display mode as the display mode of the chat messages displayed on the screen of the group chat. As a result of this, the information processing apparatus 1 is able to display the advertisement without feeling uncomfortable in the chat room.

Furthermore, the first area and the second area are arrayed in a direction perpendicular to the array direction of the chat messages displayed on the screen of the group chat, and the advertisements are displayed as a carousel display in the area that includes the first area and the second area. As a result of this, the information processing apparatus 1 is able to display the advertisements in a conspicuous manner in the chat room.

Furthermore, the second selection unit 35 reselects the advertisement on the basis of the plurality of chat messages that have been posted as evaluations of the advertisement performed by the plurality of respective users U. As a result of this, the information processing apparatus 1 is able to improve selectivity of the advertisements displayed in the chat room of the group chat.

Furthermore, the information processing apparatus 1 further includes the allocation unit 37 that allocates an advertisement rate of the advertisement displayed on the screen of the chat message as the source of a usage fee for the generative AI. As a result of this, the information processing apparatus 1 is able to easily absorb the cost needed to use the generative AI.

Furthermore, the information processing apparatus 1 further includes the decision unit 32 that decides one or more states from among the area size of at least of one of the first area and the second area, the display mode of the advertisement, and the output frequency of the advertisement on the basis of the number of users U participating in the group chat. As a result of this, the information processing apparatus 1 is able to improve a display ability of the advertisement in the chat room of the group chat.

In the above, embodiments of the present application have been described in detail based on the drawings, but the embodiments are described only by way of an example. In addition to the embodiments described in disclosure of invention, the present invention can be implemented in a mode in which various modifications and changes are made in accordance with the knowledge of those skilled in the art.

Furthermore, the “components (sections, modules, units)” described above can be read as “means”, “circuits”, or the like. For example, the acquisition unit may be read as an acquisition means or an acquisition circuit.

According to an aspect of the embodiment, an advantage is provided in that it is possible to improve selectivity of an advertisement in a chat room of a group chat.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a first selection unit that selects, based on information on a plurality of users participating in a group chat, an advertisement that is to be displayed in a first area of a screen of the group chat;
a second selection unit that selects, based on a history of conversations held among the users in the group chat, an advertisement that is to be displayed in a second area of the screen of the group chat; and
an output unit that outputs the advertisement selected by the first selection unit and the advertisement selected by the second selection unit.

2. The information processing apparatus according to claim 1, wherein
the second selection unit includes
a generation processing unit that causes generative AI to generate advertisement condition information indicating a condition for the advertisement to be displayed in the second area by inputting information including the history of the conversations held among the users to the generative AI as input information, and
a selection processing unit that selects the advertisement to be displayed in the second area based on the advertisement condition information generated by the generation processing unit.

3. The information processing apparatus according to claim 2, wherein the generation processing unit causes the generative AI to generate the advertisement condition information indicating the condition for the advertisement to be displayed in the second area by inputting information including the information on the plurality of users and the history of the conversations held among the users to the generative AI as input information.

4. The information processing apparatus according to claim 2, wherein
the generation processing unit causes the generative AI to generate base information that is information indicating a base of the condition indicated by the advertisement condition information and that is displayed on the screen of the group chat by inputting information including information that instructs to generate the base of the condition indicated by the advertisement condition information to the generative AI as input information, and
the output unit outputs the base information generated by the generation processing unit.

5. The information processing apparatus according to claim 1, wherein the second selection unit selects the advertisement to be displayed in the second area based on content of a chat message posted by one of the users from among the plurality of users and based on the history of the conversations held among the users in the group chat before the chat message is posted.

6. The information processing apparatus according to claim 1, further comprising a specifying unit that specifies a chat message posted by the user in another chat room that is other than a chat room of the group chat, wherein
the second selection unit selects the advertisement to be displayed in the second area based on the history of the conversations held among the users and based on the chat message specified by the specifying unit.

7. The information processing apparatus according to claim 6, wherein the specifying unit specifies the other chat room based on a chat message posted by the user in the chat room of the group chat.

8. The information processing apparatus according to claim 1, wherein the first selection unit selects the advertisement to be displayed in the first area based on the information on the plurality of users participating in the group chat and based on content of a chat message posted by one of the users from among the plurality of users.

9. The information processing apparatus according to claim 1, wherein the advertisements are displayed, in the first area and the second area, in the same display mode as a display mode of chat messages displayed on the screen of the group chat.

10. The information processing apparatus according to claim 1, wherein
the first area and the second area are arrayed in a direction perpendicular to an array direction of chat messages displayed on the screen of the group chat, and
the advertisements are displayed as a carousel display in an area that includes the first area and the second area.

11. The information processing apparatus according to claim 1, wherein the second selection unit reselects the advertisement based on a plurality of chat messages posted as evaluations of the advertisement performed by the plurality of users.

12. The information processing apparatus according to claim 2, further comprising an allocation unit that allocates an advertisement rate of the advertisement displayed on the screen of a chat message as a source of a usage fee for the generative AI.

13. The information processing apparatus according to claim 1, further comprising a decision unit that decides one or more states from among an area size of at least one of the first area and the second area, a display mode of the advertisement, and an output frequency of the advertisement based on the number of users participating in the group chat.

14. An information processing method executed by a computer, the information processing method comprising:
selecting, based on information on a plurality of users participating in a group chat, a first advertisement that is to be displayed in a first area of a screen of the group chat;
selecting, based on a history of conversations held among the users in the group chat, a second advertisement that is to be displayed in a second area of the screen of the group chat; and
outputting the first advertisement selected in the first selecting and the second advertisement selected in the second selecting.

15. A non-transitory computer readable storage medium having stored therein an information processing program that causes a computer to execute a process, the process comprising:
selecting, based on information on a plurality of users participating in a group chat, a first advertisement that is to be displayed in a first area of a screen of the group chat;
selecting, based on a history of conversations held among the users in the group chat, a second advertisement that is to be displayed in a second area of the screen of the group chat; and
outputting the first advertisement selected in the first selecting and the second advertisement selected in the second selecting.
